(19) United States
(12) Patent Application Publication
(10) Pub. No.: US 2011/0243423 A1
(43) Pub. Date: Oct. 6, 2011

(54) SYSTEM AND METHOD FOR INSPECTING ELECTRICAL STIMULATION LEADS

(75) Inventors: Steven Bramhall, Carrollton, TX (US); Brent Herling, Dallas, TX (US)

(73) Assignee: ADVANCED NEUROMODULATION SYSTEMS, INC., Plano, TX (US)

(21) Appl. No.: 13/070,120

(22) Filed: Mar. 23, 2011

Related U.S. Application Data
(60) Provisional application No. 61/319,676, filed on Mar. 31, 2010.

(51) Int. Cl. G06K 9/00

(52) U.S. Cl. 382/141

(57) ABSTRACT

In one embodiment, a method of inspecting a lead body comprising a plurality of wire conductors helically wound in groups separated by respective gaps, the system comprises: providing a lead body comprising a plurality of wire conductors, helically wound in groups separated by respective gaps, in transparent insulative material, in a channel of a fixture; providing a sensor module; scanning the sensor module along a substantial length of the lead body to obtain image, interferometric, or other data of the lead body; electronically processing the data to calculate respective distances from given turns within a group of the wire conductors from an other sheath of the lead body; determining whether the calculated respective distances correspond to expected values within defined tolerances; and generating an inspection report for the lead body based on the determining.

### TECHNICAL FIELD

This application is generally related to inspecting electrical stimulation leads adapted for delivery of electrical pulses to tissue of a patient.

### BACKGROUND

Neurostimulation systems are devices that generate electrical pulses and deliver the pulses to nerve tissue to treat a variety of disorders. Spinal cord stimulation (SCS) is the most common type of neurostimulation. In SCS, electrical pulses are delivered to nerve tissue in the spine typically for the purpose of chronic pain control. While a precise understanding of the interaction between the applied electrical energy and the nervous tissue is not fully appreciated, it is known that application of an electrical field to spinal nervous tissue can effectively mask certain types of pain transmitted from regions of the body associated with the stimulated nerve tissue. Specifically, applying electrical energy to the spinal cord associated with regions of the body afflicted with chronic pain can induce “paresthesia” (a subjective sensation of numbness or tingling) in the afflicted bodily regions. Thereby, paresthesia can effectively mask the transmission of non-acute pain sensations to the brain.

SCS systems generally include a pulse generator and one or more leads. A stimulation lead includes a lead body of insulative material that encloses wire conductors. The distal end of the stimulation lead includes multiple electrodes that are electrically coupled to the wire conductors. The proximal end of the lead body includes multiple terminals, which are also electrically coupled to the wire conductors, that are adapted to receive electrical pulses. The distal end of a respective stimulation lead is implanted within the epidural space to deliver the electrical pulses to the appropriate nerve tissue within the spinal cord that corresponds to the dermatome(s) in which the patient experiences chronic pain. The stimulation leads are then tunneled to another location within the patient's body to be electrically connected with a pulse generator or, alternatively, to an “extension.”

The pulse generator is typically implanted within a subcutaneous pocket created during the implantation procedure. In SCS, the subcutaneous pocket is typically disposed in a lower back region, although subclavicular implantations and lower abdominal implantations are commonly employed for other types of neuromodulation therapies.

The pulse generator is typically implemented using a metallic housing that encloses circuitry for generating the electrical pulses, control circuitry, communication circuitry, a rechargeable battery, etc. The pulse generating circuitry is coupled to one or more stimulation leads through electrical connections provided in a “header” of the pulse generator. Specifically, feedthrough wires typically exit the metallic housing and enter into a header structure of a moldable material. Within the header structure, the feedthrough wires are electrically coupled to annular electrical connectors. The header structure holds the annular connectors in a fixed arrangement that corresponds to the arrangement of terminals on a stimulation lead.

### SUMMARY

In one embodiment, a method of inspecting a lead body comprising a plurality of wire conductors helically wound in groups separated by respective gaps, the system comprises: providing a lead body comprising a plurality of wire conductors, helically wound in groups separated by respective gaps, in transparent insulative material, in a channel of a fixture; providing a sensor module; scanning the sensor module along a substantial length of the lead body to obtain image, interferometric, or other data of the lead body; electronically processing the data to calculate respective distances from given turns within a group of the wire conductors from an other sheath of the lead body; determining whether the calculated respective distances correspond to expected values within defined tolerances; and generating an inspection report for the lead body based on the determining.

The foregoing has outlined rather broadly certain features and/or technical advantages in order that the detailed description that follows may be better understood. Additional features and/or advantages will be described hereinafter which form the subject of the claims. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the appended claims. The novel features, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the appended claims.

### BRIEF DESCRIPTION OF THE DRAWINGS

FIG. 1 depicts a stimulation system according to one representative embodiment.

FIGS. 2A-2C respectively depict stimulation portions for inclusion at the distal end of a lead according to some representative embodiments.

FIG. 3 depicts a portion of a body compliant stimulation lead.

FIG. 4 depicts respective turns of conductor wires within a body compliant stimulation lead.

FIG. 5 depicts an inspection system for inspecting a stimulation lead body according to one representative embodiment.

FIGS. 6A and 6B depict a fixture for inclusion within the inspection system of FIG. 5 according to one representative embodiment.

FIG. 7 depicts an inspection system for inspecting a stimulation lead body according to another representative embodiment.

FIG. 8 depicts image data of a stimulation lead body captured according to another representative embodiment.

FIG. 9 depicts a flowchart for inspecting a stimulation lead body according to one representative embodiment.

FIG. 10 depicts a filar group patterns for detection according to one representative embodiment.

### DETAILED DESCRIPTION

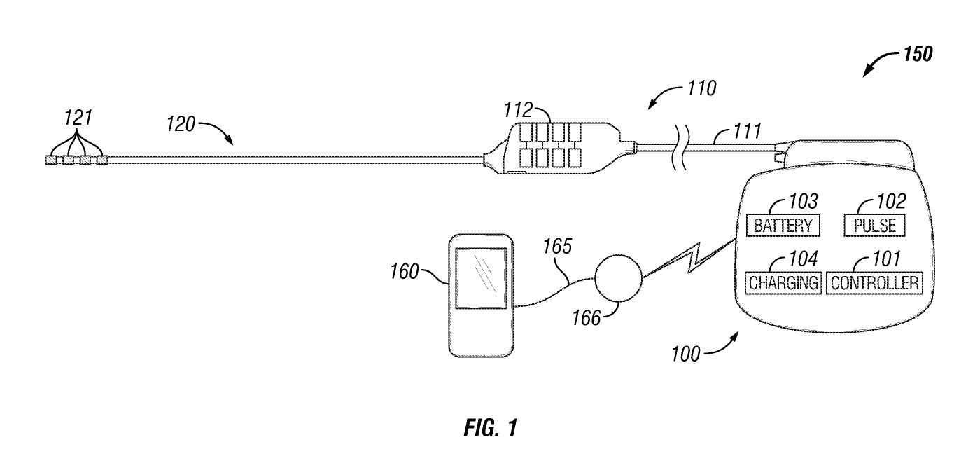

FIG. 1 depicts stimulation system 150 that generates electrical pulses for application to tissue of a patient. System 150 may be adapted to generate electrical pulses and deliver the pulses to tissue of the patient. For example, system 150 may be adapted to stimulate spinal cord tissue, peripheral nerve tissue, deep brain tissue, cortical tissue, cardiac tissue, digestive tissue, pelvic floor tissue, or any other suitable tissue within a patient's body.

System 150 includes implantable pulse generator 100 that is adapted to generate electrical pulses for application to tissue of a patient. Implantable pulse generator 100 typically comprises a metallic housing that encloses pulse generating circuitry 102, controller 101, charging coil (not shown), battery 103, far-field and/or near field communication circuitry (not shown), battery charging circuitry 104, etc. of the device. Although an implantable pulse generator is shown for the embodiment of FIG. 1, an external pulse generator (e.g., a “trial” stimulator) may alternatively be employed. The controller 101 typically includes a microcontroller or other suitable processor for controlling the various other components of the device. Software code is typically stored in memory of the pulse generator 100 for execution by the microcontroller or processor to control the various components of the device.

A processor and associated charge control circuitry for an implantable pulse generator is described in U.S. Patent Publication No. 20060259098, entitled “SYSTEMS AND METHODS FOR USE IN PULSE GENERATION,” which is incorporated herein by reference. Circuitry for recharging a rechargeable battery of an implantable pulse generator using inductive coupling and external charging circuits are described in U.S. patent Ser. No. 11/109,114, entitled “IMPLANTABLE DEVICE AND SYSTEM FOR WIRELESS COMMUNICATION,” which is incorporated herein by reference.

An example and discussion of “constant current” pulse generating circuitry is provided in U.S. Patent Publication No. 20060170486 entitled “PULSE GENERATOR HAVING AN EFFICIENT FRACTIONAL VOLTAGE CONVERTER AND METHOD OF USE,” which is incorporated herein by reference. One or multiple sets of such circuitry may be provided within pulse generator 100. Different pulses on different electrodes may be generated using a single set of pulse generating circuitry using consecutively generated pulses according to a “multi-stimset program” as is known in the art. Alternatively, multiple sets of such circuitry may be employed to provide pulse patterns that include simultaneously generated and delivered stimulation pulses through various electrodes of one or more stimulation leads as is also known in the art. Various sets of parameters may define the pulse characteristics and pulse timing for the pulses applied to various electrodes as is known in the art. Although constant current pulse generating circuitry is contemplated for some embodiments, any other suitable type of pulse generating circuitry may be employed such as constant voltage pulse generating circuitry.

Stimulation system 150 further comprises one or more stimulation leads 120. Stimulation lead(s) 120 may be intended for long-term implantation or for short-term “trial” use as known in the art. Stimulation lead 120 comprises a lead body of insulative material about a plurality of conductors that extend from a proximal end of lead 120 to its distal end. The conductors electrically couple a plurality of electrodes 121 to a plurality of terminals (not shown) of lead 120. The terminals are adapted to receive electrical pulses and the electrodes 121 are adapted to apply stimulation pulses to tissue of the patient. Also, sensing of physiological signals may occur through electrodes 121, the conductors, and the terminals. Additionally or alternatively, various sensors (not shown) may be located near the distal end of stimulation lead 120 and electrically coupled to terminals through conductors within the lead body 111.

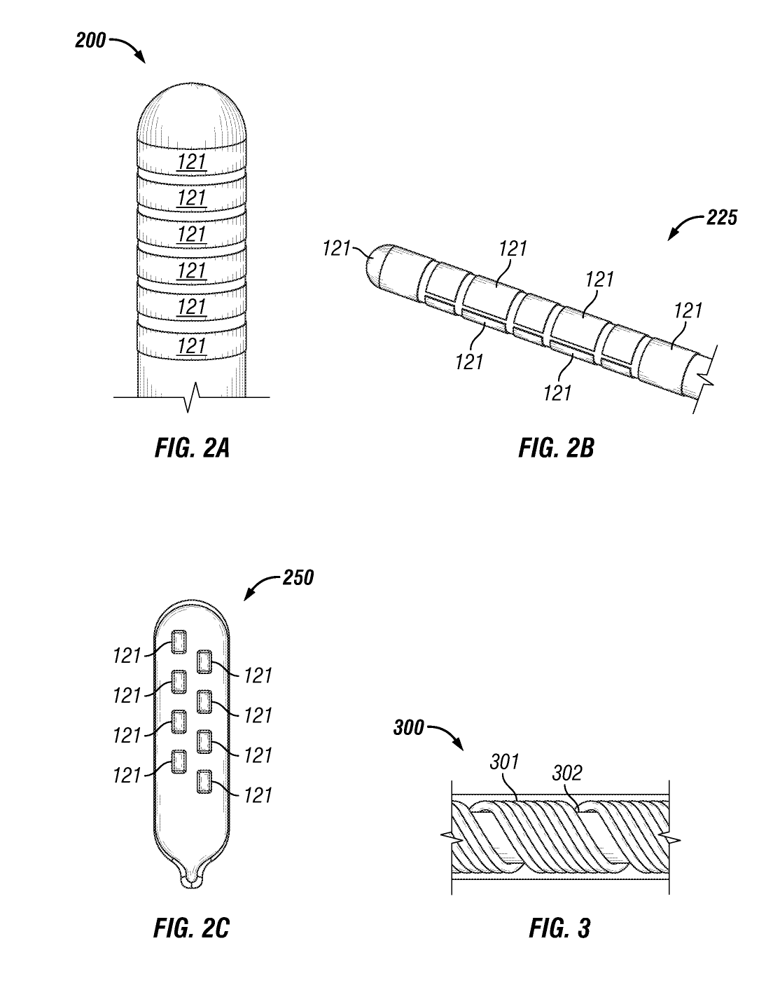

FIGS. 2A-2C respectively depict stimulation portions 200, 225, and 250 for inclusion at the distal end of lead 120. Stimulation portion 200 depicts a conventional stimulation portion of a “percutaneous” lead with multiple ring electrodes. Stimulation portion 225 depicts a stimulation portion including several “segmented electrodes.” The term “segmented electrode” is distinguishable from the term “ring electrode.” As used herein, the term “segmented electrode” refers to an electrode of a group of electrodes that are positioned at the same longitudinal location along the longitudinal axis of a lead and that are angularly positioned about the longitudinal axis so they do not overlap and are electrically isolated from one another. Example fabrication processes are disclosed in U.S. Provisional Patent Application Ser. No. 61/247,360, entitled, “METHOD OF FABRICATING STIMULATION LEAD FOR APPLYING ELECTRICAL STIMULATION TO TISSUE OF A PATIENT,” which is incorporated herein by reference. Stimulation portion 250 includes multiple planar electrodes on a paddle structure.

Stimulation system 150 optionally comprises extension lead 110. Extension lead 110 is adapted to connect between pulse generator 100 and stimulation lead 120. That is, electrical pulses are generated by pulse generator 100 and provided to extension lead 110 via a plurality of terminals (not shown) on the proximal end of extension lead 110. The electrical pulses are conducted through conductors within lead body 111 to housing 112. Housing 112 includes a plurality of electrical connectors (e.g., “Bal-Seal” connectors) that are adapted to connect to the terminals of lead 120. Thereby, the pulses originating from pulse generator 100 and conducted through the conductors of lead body 111 are provided to stimulation lead 120. The pulses are then conducted through the conductors of lead 120 and applied to tissue of a patient via electrodes 121.

In practice, stimulation lead 120 is implanted within a suitable location within a patient adjacent to tissue of a patient to treat the patient's particular disorder(s). The lead body extends away from the implant site and is, eventually, tunneled underneath the skin to a secondary location. Housing 112 of extension lead 110 is coupled to the terminals of lead 120 at the secondary location and is implanted at that secondary location. Lead body 111 of extension lead 110 is tunneled to a third location for connection with pulse generator 100 (which is implanted at the third location). For “trial” stimulation, the terminal end of lead 120 is left external to the patient's body and is coupled to the connector portion of an external pulse generator as is known in the art.

Controller device 160 may be implemented to recharge battery 103 of pulse generator 100 (although a separate recharging device could alternatively be employed). A “wand” 165 may be electrically connected to controller device through suitable electrical connectors (not shown). The electrical connectors are electrically connected to coil 166 (the “primary” coil) at the distal end of wand 165 through respective wires (not shown). Typically, coil 166 is connected to the wires through capacitors (not shown). Also, in some embodiments, wand 165 may comprise one or more temperature sensors for use during charging operations.

The patient then places the primary coil 166 against the patient's body immediately above the secondary coil (not shown), i.e., the coil of the implantable medical device. Preferably, the primary coil 166 and the secondary coil are aligned in a coaxial manner by the patient for efficiency of the coupling between the primary and secondary coils. Controller 160 generates an AC-signal to drive current through coil 166 of wand 165. Assuming that primary coil 166 and secondary coil are suitably positioned relative to each other, the secondary coil is disposed within the field generated by the current driven through primary coil 166. Current is then induced in secondary coil. The current induced in the coil of the implantable pulse generator is rectified and regulated to recharge battery 103 by charging circuitry 104. Charging circuitry 104 may also be used to communicate status messages to controller 160 during charging operations using pulse-loading or any other suitable technique. For example, controller 101 of pulse generator 100 may communicate the coupling status, charging status, charge completion status, etc.

External controller device 160 is also a device that permits the operations of pulse generator 100 to be controlled by a user after pulse generator 100 is implanted within a patient, although in alternative embodiments separate devices are employed for charging and programming. Also, multiple controller devices may be provided for different types of users (e.g., the patient or a clinician). Controller device 160 can be implemented by utilizing a suitable handheld processor-based system that possesses wireless communication capabilities. Software is typically stored in memory of controller device 160 to control the various operations of controller device 160. Also, the wireless communication functionality of controller device 160 can be integrated within the handheld device package or provided as a separate attachable device. The interface functionality of controller device 160 is implemented using suitable software code for interacting with the user and using the wireless communication capabilities to conduct communications with IPG 100.

Controller device 160 preferably provides one or more user interfaces to allow the user to operate pulse generator 100 according to one or more stimulation programs to treat the patient's disorder(s). Each stimulation program may include one or more sets of stimulation parameters including pulse amplitude, pulse width, pulse frequency or inter-pulse period, pulse repetition parameter (e.g., number of times for a given pulse to be repeated for respective stimset during execution of program), etc. IPG 100 modifies its internal parameters in response to the control signals from controller device 160 to vary the stimulation characteristics of stimulation pulses transmitted through stimulation lead 120 to the tissue of the patient. Neurostimulation systems, stimsets, and multi-stimset programs are discussed in PCT Publication No. WO 01/93953, entitled “NEUROMODULATION THERAPY SYSTEM,” and U.S. Pat. No. 7,228,179, entitled “METHOD AND APPARATUS FOR PROVIDING COMPLEX TISSUE STIMULATION PATTERNS,” which are incorporated herein by reference.

In certain embodiments, lead 120 is a “body compliant” lead that possesses mechanical characteristics that allow the lead 120 to elastically stretch in response to forces experienced with the patient's body. Also, after removal of the stretching force, lead 120 is capable of resuming its original length and profile. For example, lead 120 may stretch 10%, 20%, 25%, 35%, or even up or above to 50% at forces of about 0.5, 1.0, and/or 2.0 pounds of stretching force. The ability to elongate at relatively low forces may present one or more advantages for implantation in a patient. For example, as a patient changes posture (e.g., “bends” the patient's back), the distance from the implanted pulse generator to the stimulation target location changes. Lead 120 may elongate in response to such changes in posture without damaging the components lead 120 or disconnecting from the pulse generator 100.

The ability to elongate may be obtained by suitably modifying the helically wrapping of the wire conductors within lead 504 and by selecting a suitable elastic, low durometer polymer material (e.g. CARBOSIL™, a silicone polycarbonate urethane) for the lead body. FIG. 3 depicts lead body 300 adapted in this manner for inclusion within a body compliant lead. As shown in FIG. 3, lead body 300 includes a plurality of conductor wires that are helically wound about the central axis of lead body 300. The plurality of conductor wires are embedded within elastic, compliant insulative material. Also, the conductor wires are wound in groups, such as group 301, that are separated by respective gaps, such as gap 302, along a substantial length of lead body 300.

Fabrication techniques and material characteristics for “body compliant” leads are disclosed in greater detail in U.S. Provisional Patent Application Ser. No. 60/788,518, entitled “Lead Body Manufacturing,” filed Mar. 31, 2006, which is incorporated herein by reference. As a brief overview, fabrication of such a “body compliant” lead involves multiple processing stages. First, raw conductor wires are coated with perfluoroalkoxy (PFA). Thereafter, the wires receive a secondary coating of CARBOSIL™. A central mandrel is also coated with CARBOSIL™. The coated wires are provided on multiple spools. The coated wires are then served about the mandrel in repeating groups with a gap between served groups using a suitable wire serving system. Tubing material (e.g., CARBOSIL™) may be provided over the served wire assembly. Heat shrink material is then provided over the assembly and a reflow process occurs. The heat shrink material is removed and a portion of the assembly is cut to length. Electrodes and terminals are then provided using any suitable technique (see, for example, electrode attachment techniques disclosed in U.S. Pat. No. 7,039,470, entitled “Medical lead and method for medical lead manufacture,” which is incorporated herein by reference).

During lead fabrication, it is possible that certain operations may occur in a less than optimal manner. That is, manufacturing processes do not always achieve a 100% yield of acceptable products. For example, functional or operational characteristics on a serving system may not be completely static over a long period of time. If certain operational characteristics of a serving system deviate from acceptable tolerances, it is possible that conductor wires will be served in a non-controlled manner.

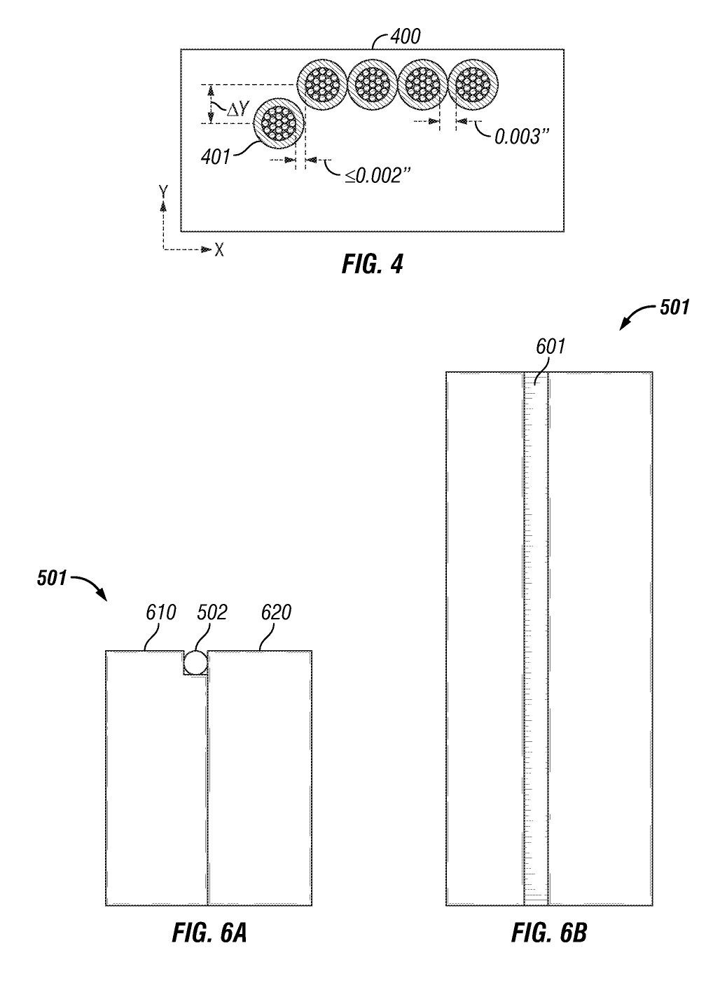

FIG. 4 is a side view of a portion of a lead body of a compliant lead. The X-direction is the axial or length-wise direction of the stimulation lead. The Y-direction represents the direction along the width of the stimulation lead (e.g., along a respective radial direction from the central axis). It is assumed, for the purposes of FIG. 4, that the various wires were all served about the mandrel using the same serving parameters (e.g., the same tension). Therefore, it is expected that each wire will be disposed at uniform positions. As seen in FIG. 4, the “good” wires are uniformly spaced from each other. In this embodiment, the wire edge-to-edge spacing is approximately 0.003 inches.

Wire 401 is the “bad” wire of the group of wires. Wire 401 is offset from its intended position. The offset may occur by application of an extraneous force on wire 401 during a dynamic variation in winding parameters during the wire serving process. As seen in FIG. 4, the edge of wire 401 is closer to the edge of the next wire (about 0.002 inches) than the intended spacing. Also, as seen in FIG. 4, wire 401 is “pulled” down from its intended position (denoted by ΔY). Specifically, wire 401 has a smaller helix diameter than the helix diameter of “good” wires. The deviation of wire 401 from its intended position is believed to be indicative that the serving process is not operating within acceptable tolerances. Accordingly, there is a higher probability of a present or subsequent fault condition (e.g., a “short” or “open circuit” condition).

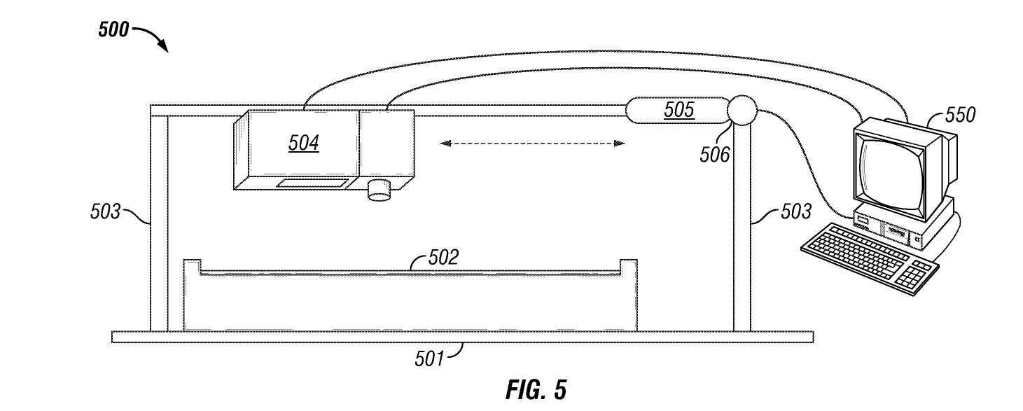

FIG. 5 depicts system 500 for inspecting a stimulation lead body to identify problematic conductors within the lead body. System 500 includes fixture 501 for holding lead body 502 for inspection. Fixture 501 may be implemented using two complementary portions 610 and 620 as shown in 6A. The complementary portions 610 and 620 are preferably positioned by the operator of system 500 to clamp lead body 502 into place. As shown in FIG. 6B, fixture 501 includes channel 601 (shown in FIG. 6A) along its length that corresponds to the outer diameter of lead body 502. Lead body 502 is preferably held within channel 601 without deformation of the lead body 502. That is, lead body 502 is preferably maintained in a relaxed state along the length of lead body 502 and lead body 502 does not exhibit localized compression or elongation that would affect the inspection process.

System 500 further comprises fixtures 503 for suspension of sensor module 504. Sensor module 504 may comprise camera, imaging, and/or interferometric components. Sensor module 504 projects visible light, infrared, UV, RF, or other energy through the insulative material of lead body 502 to measure the distance between the outer sheath surface and respective turns of the various conductors within lead body 502. In some embodiments, sensor module 504 employs interferometric techniques to acquire measurement data. In one embodiment, during a single measurement operation, sensor module 504 may operate according to known “triangulation” techniques. During triangulation, sensor module 504 projects a beam of laser light to illuminate a specific turn of a specific conductor wire. The laser light is projected as a spot for reflection off the turn of the conductor wire. The reflected light is viewed from an angle by an optical detector (e.g., a CMOS array) within module 504. The distance of the turn of the conductor wire is calculated from the resulting data using a microprocessor within module 504. Commercially available measurement devices may be employed for module 504 such as the AR700 laser distance gauge from Acuity Laser Measurement (Portland, Oreg.). Although module 504 directly provides the distance from the outer sheath in one embodiment, other embodiments may be employed. In another embodiment, pixel image data may be communicated from module 504. The distance calculations may occur on computer system 550 using software operations.

Sensor module 504 is communicatively coupled to computer system 550. Computer system 550 communicates a command to sensor module 504 to conduct one or more operations. Sensor module 504 emits visible light, infrared, UV, RF, or other energy, captures image or interferometric data, and/or calculates the appropriate distance in response to the command from computer system. The data and/or calculated distance is then communicated from sensor module 504 to computer system 550 using any suitable serial or parallel communication.

System 500 comprises driver 506 to translate sensor module 504 back and forth in a traverse direction relative to the orientation of lead body 502 in fixture 501. Driver 506 is communicatively coupled to computer system 550 and responds to commands from computer system 550 by moving sensor module 504. During initial operation, computer system 550 may vary the traverse position of sensor module 504 to ensure that the wire conductors within lead body are within the optical span of sensor module 504.

System 500 further comprises driver 505 to translate sensor module 504 back and forth longitudinally relative to the orientation of lead body 502 in fixture 501. Driver 505 is communicatively coupled to computer system 550 and responds to commands from computer system 550 by moving sensor module 504. Computer system 550 preferably varies the position of driver 505 to measure the distance of each turn of each wire from the outer surface of lead body 502 along the length of lead body 502. In an alternative embodiment, computer system 550 may instead control module 504 to measure a lesser subset of turns of the various wires.

The spacing between adjacent turns of two neighboring conductor wires within lead body 502 may also be determined according to some representative embodiments. Specifically, driver 505 is preferably a highly precise linear driver. Also, driver 505 preferably includes an encoder to accurately control the positioning of driver 505 and, hence, sensor module 504. Thereby, the distance between respective conductor wire turns along the length of lead body 501 may be determined by computer system 550.

Computer system 550 processes the positional data for the respective turns of the wires. Computer system 550 compares the received position data against the expected positions of the wires using suitable tolerances. If one or more turns deviate from an expected position by an amount greater than the defined tolerance, computer system 550 provides a suitable message to the user that a fabrication fault has occurred. Computer system 550 may also provide information pertaining to the positions of the faults within lead body 502. If there are no unacceptable deviations in lead body, computer system 550 may provide a suitable message to the operator indicating the lead body 502 has passed inspection.

In the previous discussion, it has been assumed that each wire is served using uniform serving parameters. However, if different serving parameters are employed, the wire patterns need not be uniform. For example, the winding tension may be varied between the respective wires during the winding process. One or more wires may be intended to be farther away from the outer sheath by design. Alternatively, the inter-wire pitch or spacing within a respective group may be varied. The wire pattern stored in computer system 550 is preferably individualized to the wire wrapping process used for lead body. That is, different wire patterns can be applied by computer system 550 for comparison against the measured data depending upon the fabrication process selected for lead body 502. For example, FIG. 10 depicts an axial cross-sectional view of a lead with filar group patterns 1001 for detection according to one representative embodiment. For such a lead, the first and last conductors in each filar group comprise smaller helix diameters than the inner conductors of the respective filar groups by design. Fabrication of a lead body include such filar group patterns are disclosed in greater detail in concurrently filed U.S. patent application Ser. No. ______, docket number 10-008PRO, entitled “METHOD FOR FABRICATING A STIMULATION LEAD AND STIMULATION LEAD FOR APPLYING ELECTRICAL PULSES TO TISSUE OF A PATIENT,” which is incorporated herein by reference.

In system 500, the hardware used for computer system 550 may be any conventional computer system including commercially available personal computers. Computer system 550 deviates from conventional computer systems in regard to the software stored in and executed by computer system 550. Computer system 550 comprises code for performing and/or controlling each respective task discussed herein. For example, the software of computer system 550 includes code for communicating with and controlling drivers 505 and 506 of system 500. The software also includes code for communicating with and controlling sensor module 504. Additionally, the software includes code for comparing the positional data against the expected positions of the conductor wires. The expected positions of the conductor wires may be stored within the logic of the software code. Alternatively, the expected positions of the conductor wires may be stored in one or more separate data files. The software also includes code for communicating the inspection results to the operator of system 500. The software code may also include code for storing inspection data in various files and/or databases for quality and regulatory purposes.

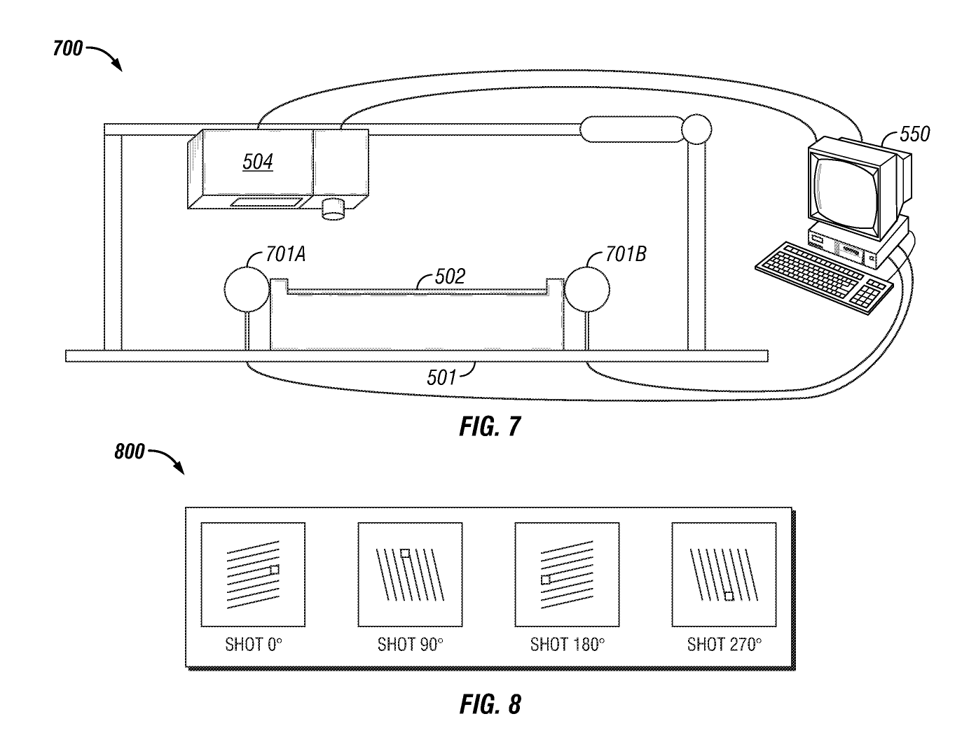

Although system 500 employs drivers 505 and 506 to translate the sensor module 504 to inspect different portions of lead body 502, other arrangements may be alternatively employed. For example, lead inspection system 700 as shown in FIG. 7, lead body 502 may be advanced through channel 601 of fixture 501 by employing multiple controllable spools 701a and 701b on opposite sides of channel 601 to unspool and uptake lead body 502. Controllable spools 701a and 701b comprise respective drive motors to let out and take up lead body 502 during operation of system 700. In such an arrangement, sensor module 504 may be fixed while lead body 502 is advanced through channel 601 by the operation of the respective spools 701a and 701b. Also, in this embodiment, fixture 501 does not clamp the lead in place. Instead, channel 601 of fixture is adapted to provide a low-friction surface to guide lead body 502 through fixture 501 during the inspection process. In another embodiment, fixture 501 may be omitted and lead body 502 may be freely suspended by tension applied on lead body 502 between spools 701a and 701b.

In another embodiment, spools 701a and 701b are rotatable to provide image data from multiple angles of lead body 502. In one embodiment, spools 701a and 701b alternate between twisting and pulling lead body 502. That is, computer system 550 uses sensor module 504 to capture image data of a respective conductor group at a respective point along lead body 502. The image data is stored for analysis. Computer system 550 advances lead body 502 by a distance equal to the conductor group length (e.g., 1/16″). Computer system 550 further controls spools 701a and 701b to rotate by 90° thereby twisting lead body 502. This process is repeated until the appropriate length of lead body 502 is inspected. The image data may be processed concurrently with the advancement of lead body 502. Alternatively, the image data may be processed after a given portion or all of the image data is captured. FIG. 8 depicts image data 800 captured across 360° rotation of a lead body according to one representative embodiment.

In system 700, computer system 550 processes the image data to identify appropriate conductor characteristics. Computer system 550 utilizes the determined characteristics against expected values and defined tolerances in a similar manner as discussed above in regard to system 500. Also, during the operation of system 700, lead body 502 is maintained in a substantially constant mechanical state during the various operations. That is, lead body 502 preferably does not exhibit localized compression or elongation deviations that would affect the inspection process. This may occur by controlling the tension and/or torque applied to lead body 502 during the respective operations.

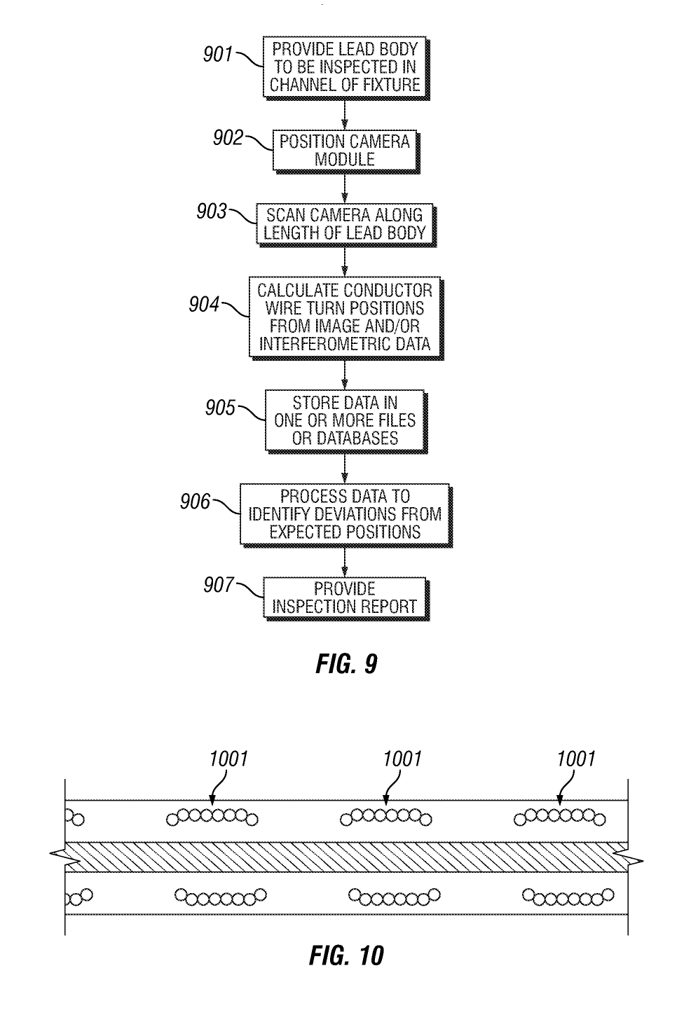

FIG. 9 depicts a flowchart for inspecting a stimulation lead body according to one representative embodiment.

In 901, a lead body is provided in a channel of a suitable fixture. In one embodiment, the channel clamps to the lead body to hold the lead body in place. Also, the fixture is preferably adapted for optical inspection. That is, a line of sight is provided by the fixture for illumination by a suitable optical source (e.g., a laser). Further, the fixture preferably provides contrast with the wires of the lead body to improve the optical detection of the positions of the various turns of the wires of the lead body.

In 902, a sensor module is transversely positioned such that the span of its optical output encompasses the possible positions of the turns of the lead body.

The sensor module is scanned along the length of the lead body (903) by moving the sensor module or by translating the lead body. The sensor module provides image or measurement data for each position along the length of the lead body. At each such position, the sensor module provides optical energy and captures optical energy using an optical detector (e.g., a CMOS array). The image and/or interferometric data is employed to calculate the positions of the respective turns of the various wires of the lead body (904). The positions may be calculated by the sensor module and/or by the controller computer system.

The resulting data is stored by the controller computer system (905) in one or more data files and/or databases. The data is processed to identify whether any turns of the wire conductors deviate from expected positions by more than defined tolerances for the lead body (906). For example, the data may be processed to compare the measured distance from the outer sheath of each measured turn against expected distances. Also, the data may be processed to compare the measured distances between conductors in a given conductor group of the lead body against expected distances. The data may be processed to compare the measured length of the gap between two successive conductor groups in the lead body against an expected distance.

If any deviations are identified, the positions of the deviations are stored on one or more data files and/or databases to permit subsequent inspection of the lead body for quality review purposes (907). The controller computer system may also permit an operator of the lead inspection system to view image data associated with the deviations during the inspection or at a later time.

In 908, an inspection report is provided to the operator. The inspection report details whether the lead body passed inspection, the number of deviations (if any), the locations of the deviations, and any other suitable data.

Although certain representative embodiments and advantages have been described in detail, it should be understood that various changes, substitutions and alterations can be made herein without departing from the spirit and scope of the appended claims. Moreover, the scope of the present application is not intended to be limited to the particular embodiments of the process, machine, manufacture, composition of matter, means, methods and steps described in the specification. As one of ordinary skill in the art will readily appreciate when reading the present application, other processes, machines, manufacture, compositions of matter, means, methods, or steps, presently existing or later to be developed that perform substantially the same function or achieve substantially the same result as the described embodiments may be utilized. Accordingly, the appended claims are intended to include within their scope such processes, machines, manufacture, compositions of matter, means, methods, or steps.

1. A system for inspecting a lead body comprising a plurality of wire conductors helically wound in groups separated by respective gaps, the system comprising:
a sensor module for capturing image data of turns of wire conductors through transparent insulative material of the lead body;
one or more drive units for translating the lead body or the sensor module to permit the sensor module to capture image data at different longitudinal positions along the lead body; and
a computer system communicatively coupled to the sensor module and the one or more drive units, the computer system controlling the sensor module and the one or more drive units, the computer system processing data received from the sensor module to determine whether distances of respective wire conductors turns from an outer surface of the lead body correspond to expected values within defined tolerances, the computer system generating inspection data for an operator of the system indicative of whether the lead body passes inspection.

2. The system of claim 1 wherein the computer system is further adapted to determine whether distances between conductors within a given group correspond to expected values within defined tolerances.

3. The system of claim 1 further comprising:
a fixture defining a channel for clamping about the lead body to hold the lead body in a fixed position.

4. The system of claim 3 wherein the fixture comprises two portions that are pressed together to clamp about the lead body.

5. The system of claim 1 further comprising:
a fixture with a low friction channel to permit the lead body to be advanced through the channel.

6. The system of claim 1 wherein the one or more drive units comprise:
a first drive unit for changing a position of the sensor module transversely relative to the lead body; and
a second drive unit for changing a position of the sensor module longitudinally relative to the lead body.

7. The system of claim 1 wherein the one or more drive units comprise:
a first spool for letting out a portion of the lead body; and
a second spool for taking up a portion of the lead body.

8. The system of claim 1 wherein the sensor module comprises a laser component to provide a spot of laser light on a respective turn of one conductor wire of the lead body.

9. The system of claim 8 wherein the sensor module is operable to automatically calculate a distance of the respective turn of the one conductor wire from an outer surface of the lead body.

10. The system of claim 1 wherein the sensor module is adapted to capture image data of each conductor turn of a respective group of the lead body in one image.

11. A system for inspecting a lead body comprising a plurality of wire conductors helically wound in groups separated by respective gaps, the system comprising:
a sensor module for capturing image data of turns of wire conductors through transparent insulative material of the lead body;
one or more drive units for longitudinally advancing the lead body and rotating the lead body to permit the sensor module to capture image data at different longitudinal positions and different angular orientations along the lead body; and
a computer system communicatively coupled to the sensor module and the one or more drive units, the computer system controlling the sensor module and the one or more drive units, the computer system processing image data of each conductor turn within a given group of conductors to determine whether a conductor pattern within image data corresponds to expected conductor characteristics within defined tolerances, the computer system generating inspection data for an operator of the system indicative of whether the lead body passes inspection.

12. The system of claim 11 wherein the computer system calculates inter-conductor spacing within a given group of conductors by processing image data.

13. The system of claim 11 wherein the one or more drive units comprises:
a first spool for letting out a portion of the lead body; and
a second spool for taking up a portion of the lead body.

14. The system of claim 13 wherein the first and second spools are rotatable.

15. The system of claim 13 wherein the computer system is adapted to display image data of a group of conductors with a conductor pattern deviating from expected conductor characteristics.

16. The system of claim 13 wherein, when the computer system identifies conductors groups having conductor patterns deviating from expected conductor characteristics, the computer system stores positions of the deviating conductor patterns in one or more data files.

17. A method of inspecting a lead body comprising a plurality of wire conductors helically wound in groups separated by respective gaps, the system comprising:
providing a lead body comprising a plurality of wire conductors, helically wound in groups separated by respective gaps, in transparent insulative material, in a channel of a fixture;
providing a sensor module;
scanning the sensor module along a substantial length of the lead body to obtain image data of the lead body;
electronically processing the image data to calculate respective distances from given turns within a group of the wire conductors from an other sheath of the lead body;
determining whether the calculated respective distances correspond to expected values within defined tolerances; and
generating an inspection report for the lead body based on the determining.

18. The method of claim 17 wherein the electronic processing is performed by circuitry in the sensor module.

19. The method of claim 17 wherein the electronic processing is performed by a computer system.

20. The method of claim 17 wherein the providing a lead body comprises:
clamping two portions of the fixture about the lead body.
